(19) United States
(12) Patent Application Publication
(10) Pub. No.: US 2008/0320043 A1
(43) Pub. Date: Dec. 25, 2008

(54) OfficerAssist

(76) Inventor: James W. Masten, JR., Seattle, WA (US)

Correspondence Address: James W. Masten, Jr., 8528-14th Ave. NW, Seattle, WA, 98117, US

(21) Appl. No.: 11/868,096

(22) Filed: Oct. 5, 2007

Related U.S. Application Data
(60) Provisional application No. 60/850,423, filed on Oct. 10, 2006.

(51) Int. Cl. G06F 17/30

(52) U.S. Cl. 707/104.1; 707/E17.01

(57) ABSTRACT

OfficerAssist (OA) is a uniquely configured system of software programs to automate the collection of digitally recorded data (audio, still images and video) from the end-user, to an archival system that manages the archive such that the data is evidentiary. OfficerAssist takes advantage of the current generation of digital recorders, still image cameras and video cameras that connect to a Windows platform as a USB memory device. Description of an enhanced device is included.

### CROSS-REFERENCES TO RELATED APPLICATIONS

This application claims priority to U.S. Provisional Application 60/850,423 filed on Oct. 10, 2006. The foregoing application is hereby incorporated by reference in its entirety as if fully set forth herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

An important aspect of any police investigation is that data gathered must be “evidentiary” to be used in a court of law. Obviously, to be evidentiary the evidence must be protected from tampering or being altered while in protective custody or storage. This is necessary for evidence found or discovered by police agencies as they investigate a crime after the fact. However, the requirements are different if the evidentiary material that is being protected is the real-time recording of the actual behavior of the police themselves. In this case, the protective custody or storage requirements are a necessary, but not sufficient, requirement to be “evidentiary.”

In order to be evidentiary, the real-time recorded data—audio, video, photographic—must be protected from the moment they are recorded. This is necessary. To achieve protection, the systems collecting the data must be secure (to prevent tampering) and reliable (to ensure recording of all the data all the time). To be sufficient, the system must be supported by manual procedure or electro-mechanical automation, so that all of the relevant activity (citizen-officer interaction) is recorded. Thus “reliable” takes on the additional dimensions of availability and robustness. Manual procedures for single-occupant patrol cars are not easily converted to evidentiary process, while automation can be the basis for evidentiary data collection.

Reliability, then, depends on two qualities: robustness and availability. To be robust, the recording system must have built-in redundancy or be built in such a way that component or system failure is remote to the point of being rare. Availability means that the system is always operating when it should be operating: by definition, police monitoring systems that are designed to be “available” and secure cannot have on and off switches that are elective in operation.

All of the systems that are currently in use to monitor the behavior of the police activity while in contact with a citizen are not truly evidentiary because they fail in one or more of these critical dimensions: their controls are necessary, but not sufficient, to safeguard the collected data. The system described herein is the first to meet all the critical requirements, necessary and sufficient, to produce evidentiary audio, video, photographic data.

It is well known in the industry how to produce video systems that turn on when the officer turns on his emergency lights. It is also well known in the industry how to automatically turn on a radio that links the officer's voice back to the car so that even when the officer is out of the vision of the camera, his voice is being recorded.

It is not well known in the industry how to produce a data recording audio system (audio, video or both) that works if he is outside radio range or if other radio signals interfere with his transmission. Radio links in these current industry systems are not robust. These systems use the radio link to carry the complete conversation between the citizen and the officer, and they are bandwidth challenged. The radio works well as the officer gets out of the car and walks to the citizen. But if there is a foot chase or a physical confrontation, there is a high probability that there will be lost data. They are also particularly vulnerable to interference from other radios or devices in the vicinity with frequencies that may conflict with their transmitting frequency.

It is well known in the industry how to produce a digital data recorder (audio, video or both) to solve some of the problems of robustness that plague the radio. The recorder is mounted on the officer, which addresses the radio's principal robustness issue. But the industry standard recorder suffers from availability issues. The radio, when within range, transports data and stores it at the receiver on a real-time basis. Currently, the only “evidentiary” way to collect the data from a recorder is to physically collect the recorder itself and use a systematic procedure involving trained neutral staff personnel to retrieve and store the recorded data. It is a practice well known in the industry to issue recorders to officers already in the ON state, then require the officers to turn them back in at the end of their shift still in the ON state. This practice creates a large data management situation as each officer returns with 10 hours of voice data on his recorder. As with any manual practice, this routine is expensive, cumbersome and subject to failure. Using this practice, accidental deletions may still occur when manually transferring data from the recorder to a central repository.

The OfficerAssist software system, herein described, automates the collection and management of the digital data to increase reliability and security. The OfficerAssist automated collection of the digital data provides a step forward in solving the digital recorder availability issues.

Another aspect of the digital recorder availability is the recording ON/OFF switch. It is well known in the industry how to produce a recorder that includes a Record On/Off switch to be manually controlled by the using officer. This industry standard allows the officer to turn on or off the recording device and undermines its availability and security, compromising the “evidentiary” nature of the data.

It is not well known in the industry how to produce a digital recorder to include a high reliability command and control link to address the automated turning on/off of the digital voice recorder. The system described herein uses a radio that was not developed as a voice link; instead it uses an IP mesh radio that was designed to send low bandwidth digital commands and data over very great distances. Said radio has the ability to send commands more than 40 miles in the country and more than seven (7) miles in dense urban environments with extremely high levels of radio interference. If there are other radios of the same mesh network, the built-in mesh technology will search for the addressed radio across the entire mesh coverage area.

This use of remote commands to control the initiation of recording increases the robustness and availability of said digital recording system by eliminating the manual step in turning on the recording. To further ensure that the system meets the requirements of availability, there is no manual means by which the using officer may turn OFF the OfficerAssist digital voice recorder. The herein described system requires that the recording device be connected to a workstation with a path to deposit the data into protective custody before it will allow the officer to turn the device OFF, via commands given to the program running on said workstation.

### BRIEF DESCRIPTION OF THE SEVERAL VIEWS OF THE DRAWINGS

Other features and advantages of the present invention will become apparent in the following detailed descriptions of the preferred embodiment with reference to the accompanying drawings, of which:

FIG. 1: Overview of OfficerAssist Software System and the Enhanced Digital Recorder with IP Mesh Link Radio System, Featuring the Three Software Subsystems;

FIG. 1a: Overview of the OfficerAssist Software System and the Enhanced Digital Recorder with IP Mesh Link Radio System, with Individual Subcomponents Indicated;

FIG. 2: The Functional Diagram of the Digital Recorder with a Two-Way Radio Link to a Control Computer Automating Situational Response;

FIG. 3: Overview of how the OfficerAssist Unit Uses IP Technology to Uniquely Identify OfficerAssist Units and Maintain Control Links In the Field When Multiple Responders Are Present;

FIG. 4: Screen Shot of Administrative;

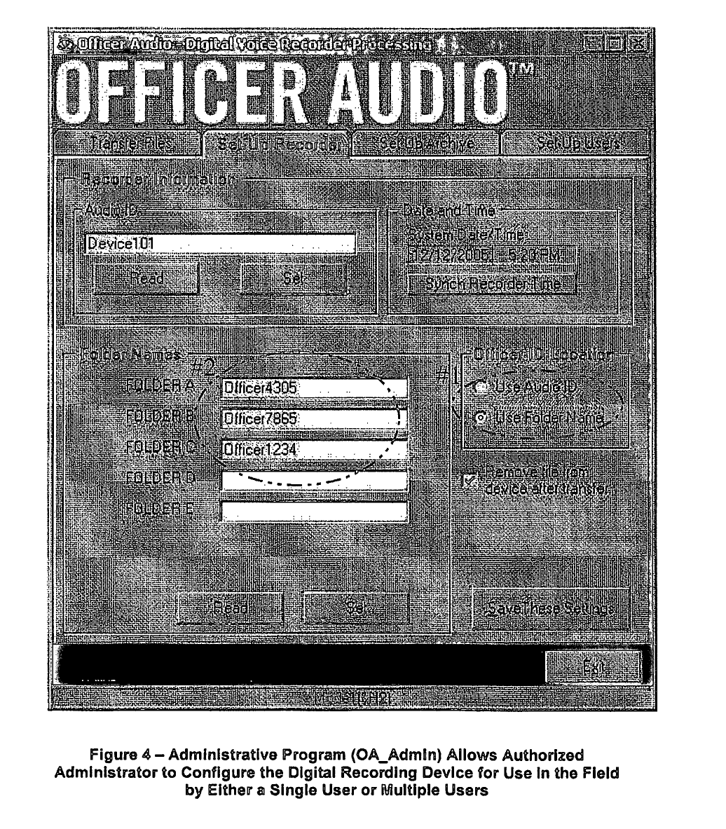

FIG. 5: Screen Shot of Server-based System Manager;

FIG. 6: Screen Shot of calendar showing which days have retrievable data;

FIG. 7: Screen Shot of at-a-glance chart showing type of data available for device;

FIG. 8: Screen Shot of ShowPics Page.

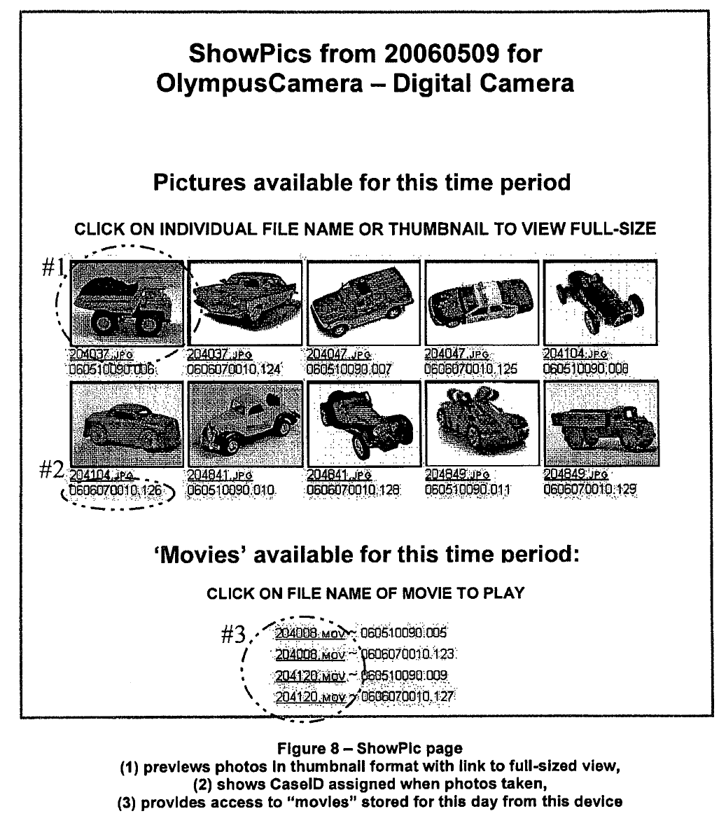

### SPECIFICATION

The herein-described digital recording and storage system, OfficerAssist, comprises two main subsystems, each with its own subcomponents.

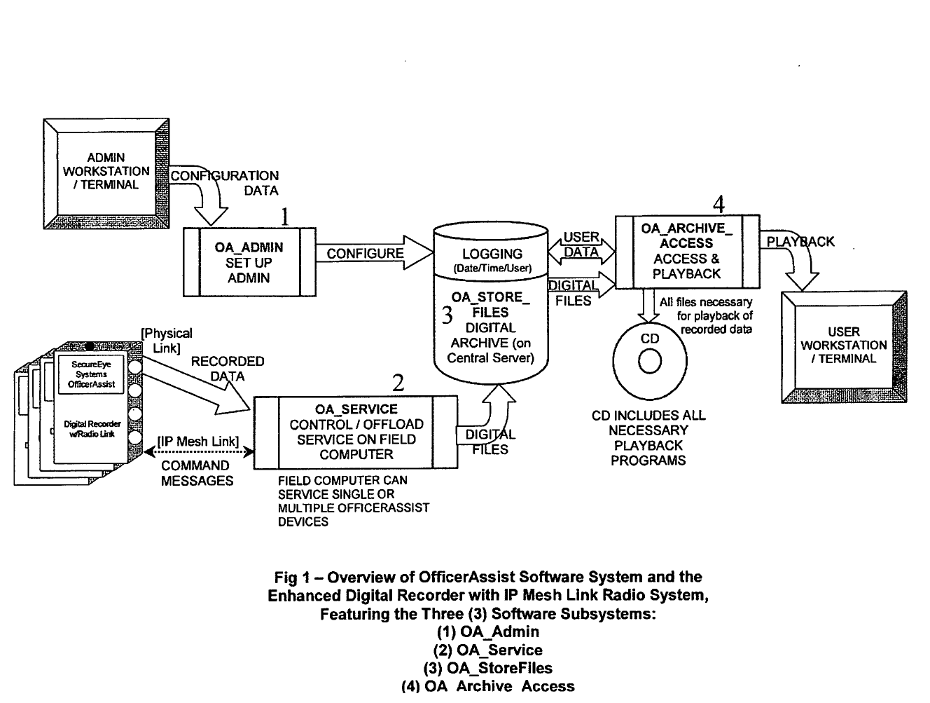

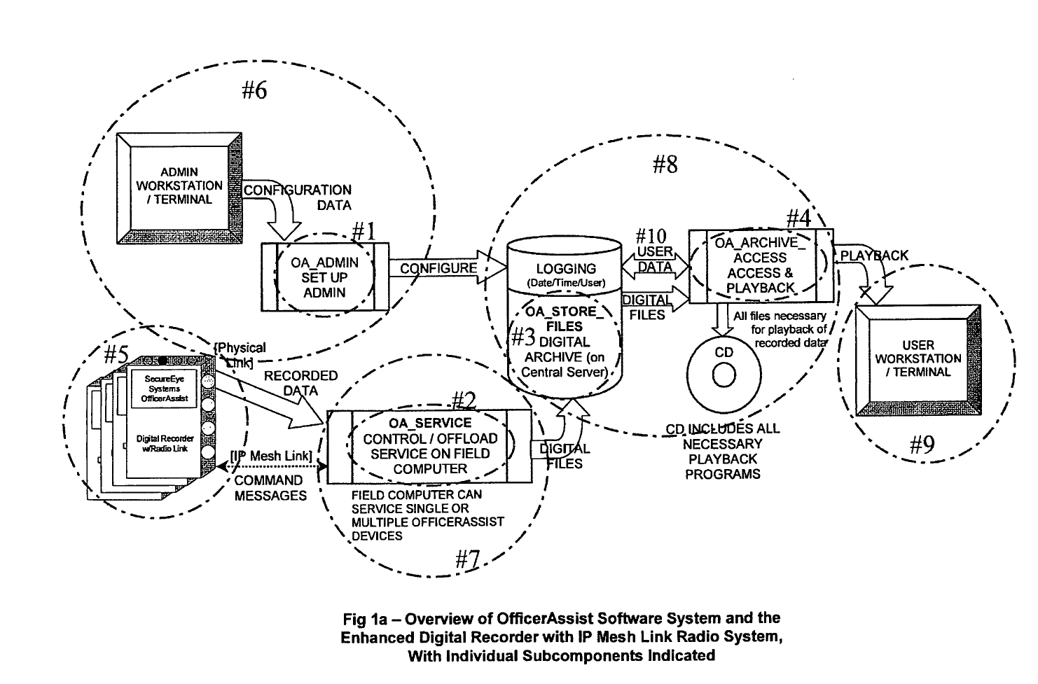

1) The software subsystem, comprising three (3) subcomponents:
OA_Admin: The administrative tool that allows properly authorized personnel to setup and configure the recording devices and archival system.
OA_Service: The hidden device interface component that recognizes devices, offloads data, processes data into appropriate format for archive storage.
OA_Store_Files: The server-based program that archives and logs all digitally recorded data, with ancillary data, into a database on the server.
OA_Archive_Access: The web-based GUI that allows authorized users access to the archived recorded data for listening/viewing.
   2) The Officer Worn hardware subsystem, comprising (5) subcomponents:
IP-based radio link
Audio recording subcomponent
Video recording subcomponent
Robust 24-hour battery system with 8-hours of reserve capacity
Sub-System Interface supporting data-centric device augmentations
   Driver license bar code/magnetic stripe scanning subsystem
   Audio output (ear-piece)
   Fingerprints
   Iris imaging
      OfficerAssist is realized as three programs. (See FIG. 1)

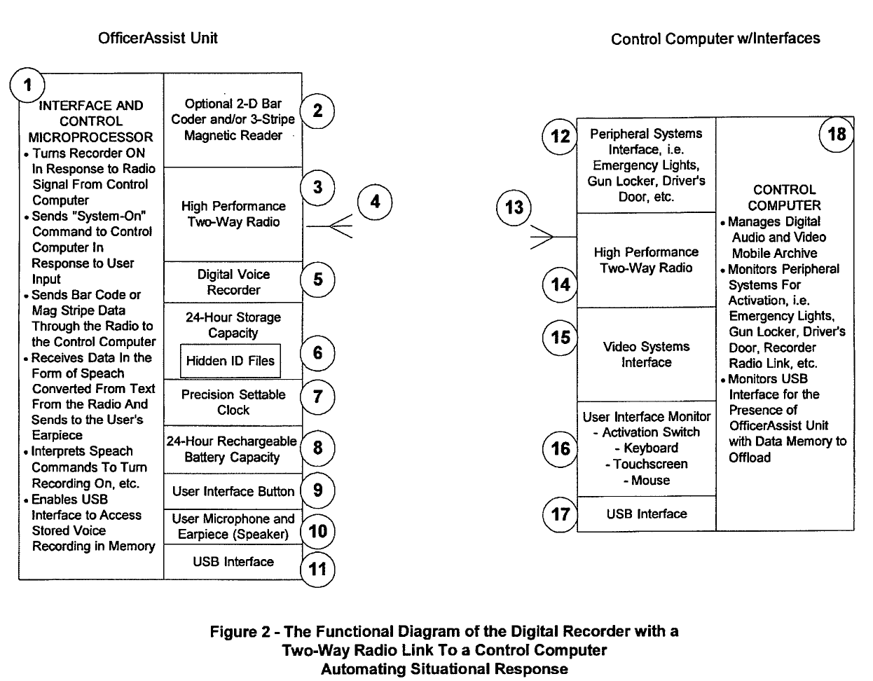

The first component of the Software subsystem is the “Administrative” program (OA_Admin). (FIG. 1 #1, FIG. 1a #1) This program enables an administrator to connect the digital recording device (FIG. 1a #5) to a workstation (FIG. 1a #6) on which the OA_Admin program is running. The OA_Admin program creates a coded, hidden identification file on the device to enable the future automatic identification of the recording device by the officer/user's patrol computer. (FIG. 1a #7, FIG. 2 #7) This hidden file contains several identifying strings that contain the type of device and the ids of current user or users.

There are two modes of operation for the devices, configurable by the administrator via the OA_Admin program: single user or multiple users per device. In one mode of operation, the hidden file contains the identification of the single user. In the alternative mode of operation, a system of folders contains the identification information for the multiple unique users, one user per folder. Thus each user can record his uniquely identifiable data when he gains possession of the recording device, and each user's recorded data is discernible from those recorded by a different user on the same device when offloaded to central archive storage.

The second component is the hidden interface to connect to the device through the officer/user's patrol computer. A fundamental aspect of this component is the management of the recorded data that requires no interface, no skill or understanding of the connected computer by the officer/user. It is sufficient in the realm of OfficerAssist for the officer/user to just connect the recording device to the USB connector on the computer and watch for the recording device to indicate that the device is ready for disconnection from the workstation computer. This data management function is provided by the hidden device interface component of the OfficerAssist suite of programs (OA_Service).

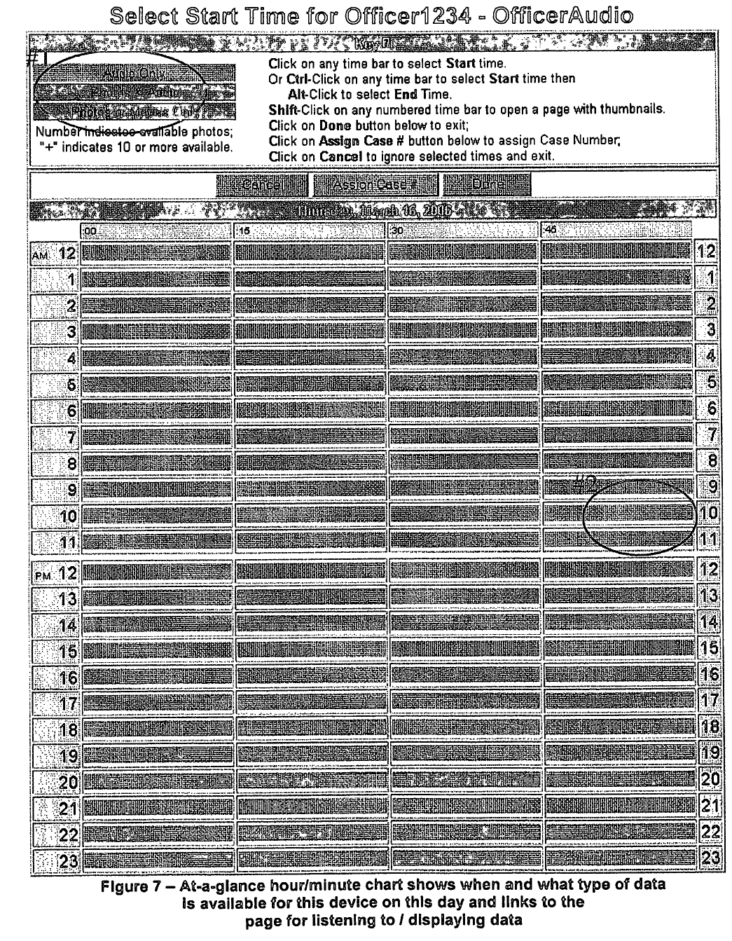

Said OA_Service runs as a service or background program on a continuous basis in a user's field deployed computer (FIG. 1a #6). The OA_Service is a program that monitors the messages to Windows from new devices to detect the connection event of the monitored device. The OA_Service program then looks inside the USB memory devices for the appropriate OfficerAssist hidden file (as written by the OA_Admin program, described above). If it finds the hidden file then it recognizes the device and knows which device is connected; it then discerns whether data is available for upload from the device. The OA_Service program removes the data, and repackages the audio and video data into one-minute files, marking the uploaded files as to which device and user it derived from. During the conversion process, partial-minute files are processed to pad the files out to one minute exactly. Considerations are given to multiple short segments of data that all reside within a single minute, padding where appropriate for future playback and synchronization. This repackaging technique is uniquely enabling in that it allows a first level of editing (e.g., redacting) by the unskilled user in the selection of audio and video segments for relevance and security reasons (FIG. 7 #2). OA_Service will monitor the status of various subsystems in the car and determine whether it is time to turn OFF the recording of the digital data. OA_Service optionally performs some other worthwhile services such as resetting the local clock if it is different from the local workstation time. All of this happens without any keystrokes or activity on the part of the creator of the digital data contained in the digital recorder.

The processing of the off-loaded data moves to the third program, the OA_Store_Files program (FIG. 1, #3 and FIG. 1a, #3, #8). The OA_Store_Files program uses a database to keep track of the entries for captured digital data that are automatically extracted from the recording devices. This program stores the digitally recorded data files in the appropriate area in the archive (based on device and user), logs entries into the server's database for each file, along with ancillary or citizen-based data associated with it, for future retrieval by the OA_Archive_Access Program (FIG. 1 #4).

This fourth program, OA_Archive_Access, runs on a central server and is accessed via an authorized workstation (FIG. 1a #4, #8, #9). The Archive Program protects the evidentiary integrity of the data by managing access to the data and creating an extensible audit of any contacts with the data, to include who, when, what data and from which machine. (FIG. 1a #10) Any exports of copies of the data create additional entries into the database that denote who, when and exactly what data was copied to either an evidentiary format CD/DVD or a copy of the data for transcription by either CD/DVD or by wired or wireless network.

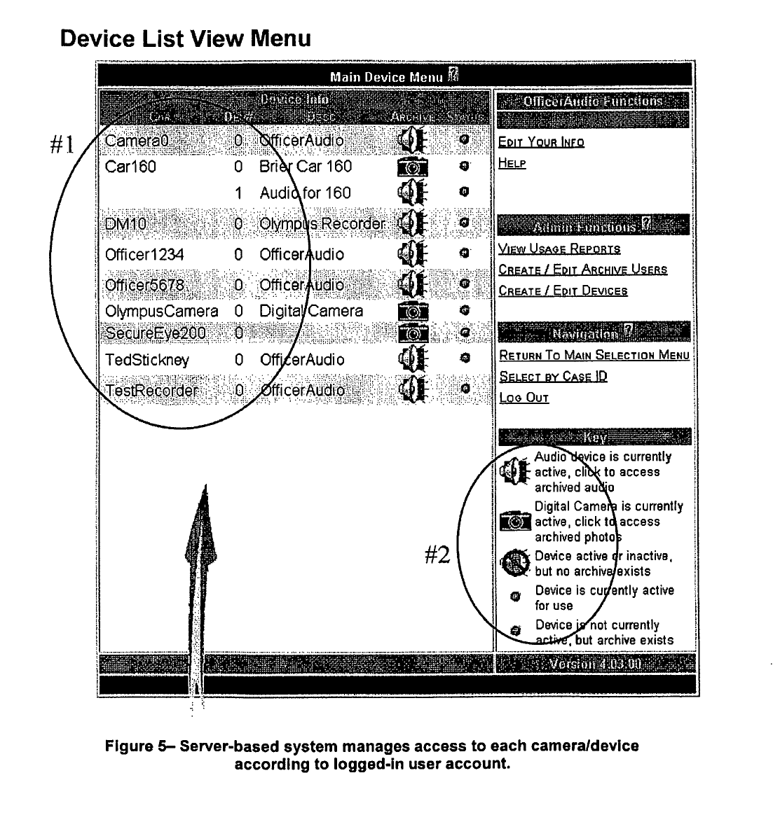

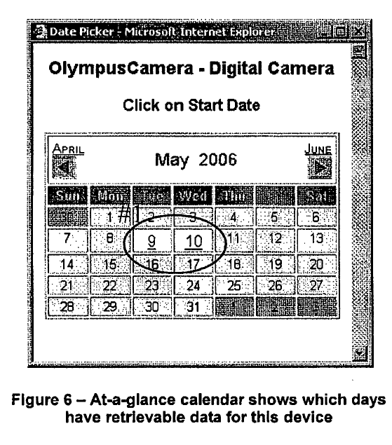

The OA_Archive_Access program provides a Graphical User Interface (GUI) that serves approved consumers of the evidentiary data managed and preserved by OfficerAssist. The GUI enables the efficient survey, review and discovery of captured and archived evidentiary digital data, while isolating the user from the necessity of interacting directly with the computer operating system's file structure. Thus preserving the evidentiary value of the archived data and allowing only the approved perusal of the data while creating an accurate audit of all reviewers and users. A unique feature of this graphical user interface (GUI) enables the user to make “at-a-glance” evaluations for both the existence and the timeliness of the captured digital data without engaging or using the computer's operating system. Initially, the system allows entry into the storage index by media or capture device type (FIG. 5 #s 1 and 2). The unique GUI offers a hierarchical index of device assignments that can be traversed very efficiently using only mouse clicks. A calendar displaying a month of days where a BOLDed date represents a date with valid digital data (FIG. 6 #1). After the desired device, user or date and time is located then the system will display 24 hours of data history using 24 horizontal bars of 60 small blocks each representing one minute (FIG. 7 #1 and 2). The minute ticks are color coded to represent audio or video captured for that minute, and numbers within these ticks indicate the availability of still pictures.

### Hardware Components

It is well known in the industry how to produce digital recorders that connect to the computer as USB memory devices. It is also well known how to produce digital recorders that provide a radio link back to the officer's patrol vehicle. It is not well known how to produce a digital recording device that combines the ability to radio live data to the vehicle, store recorded data locally when out of range of said radio, and which provides a high-performance IP wireless link to the computer. Said wireless link enables a bi-directional variable rate of communications to the computer. (FIG. 2 #s 1-11)

The wireless link is used to support both end-user-driven communication and automated communication used to control and coordinate functions in both the digital recorder and the computer, said computer may be located in a vehicle. (FIG. 2 #s 12-18)

The recording device, in the preferred embodiment, may be signaled to begin recording via a high reliability radio link sent from the computer or dedicated electronics in response to a change to the monitored electrical subsystem in the car. (FIG. 2 #12) Typical subsystems monitored in such a remote mobile environment, might be: door open switches, firearm locker switches or vehicle speed, heading, braking or airbag deployment.

It is well known how to produce a digital recorder with a function to set its time as synchronized with the local workstation time when it is connected to said workstation. It is not well known how to provide the routine synchronization of the local clocks of both systems. Synchronization of the local clocks guarantees that multiple digital recorders will have the same time reference as the wirelessly linked computer (FIG. 2 #7). Said time synchronization will make all recording synchronized to the local computer time. It is a separate but not uncommon practice to synchronize all computers using a wireless network time reference or even to use GPS time as a ubiquitous synchronizing reference. It is uncommon to synchronize local digital recorders using a wireless link, such that playback of any recorded material will be synchronized across all recorders in a given situation theater.

Furthermore the wireless link has sufficient bandwidth that if the digital recorders are within range of the computer, a “Live View” stream of digital data (audio, video or controls) can be maintained to keep support team members who are located at the computer aware of the field situation. If the field personnel move to locations not served by the wireless link, then only the live view is lost. The full fidelity digital data will be recorded and preserved. When the digital recorder is returned to the computer and connected as a USB memory device, the computer will recognize the device and its user and appropriately extract the data and automatically insert it into the archive.

Said wireless link can be used to turn on all of the digital recorders associated with the local computer. The end user can manually or verbally input a command to the remote wireless recorder such that a wireless command is sent to the local computer to initialize all recording activity. (FIG. 2 #s 9 and 10) This manually or verbally given command could optionally cause the local computer to send an emergency call for help out over yet another, longer range wireless system associated with the local computer or optionally a vehicle providing docking/communications accommodations for the local computer.

This action will be expanded to include other subsystems connected to the wirelessly enhanced digital recorder. For example, bar code readers, finger print readers, iris imagers, etc., will collect information, send it through the wireless link to the computer in the vehicle, (FIG. 2 #s 2 and 3) At the vehicle the information is retransmitted over a more powerful, longer range wireless system for interpretation or to associate acquired information with other stored material with the read information. This remotely archived data could be sent back to the local computer where it is converted from text to speech and sent from the local computer to the digital recorder through the local wireless link. This speech data, when it gets to the local recorder, is delivered audibly into an earpiece in the end user's ear. (FIG. 2 #10)

It is uncommon in use today, but very necessary, that a record be made of the exact time and time sequence as to the request for additional information and the delivery of said information to the requesting field officer. Noting what time it was sent to the vehicle computer is necessary but not sufficient. Knowing what time it was put into the officer's ear is required.

The delivered information will be retained by the digital recorder and by verbal command from the end user will be repeated into the end user's earpiece. When the digital recorder is connected to the local computer via the USB port (FIG. 2 #11) to have the stored digital data automatically removed for archiving, the audit record of what data was sent to the remote digital recorder and when it was received and played into the end user's ear is noted and is also sent to the archive.

The significant advantage to the digital recorder linked to the control computer through a high performance mesh IP radio link is the guarantee of high quality audio recording accurately synchronized to the control computer no matter how many additional radios are present in the local area. Since, the IP radio is only used to send timely but very brief commands, the available bandwidth will support tens of thousands of control computers and hundreds of thousands of digital recorders without at all limiting the performance of the audio recording. In fact, the incorporated mesh technology means that greater numbers of radios means a greater coverage area.

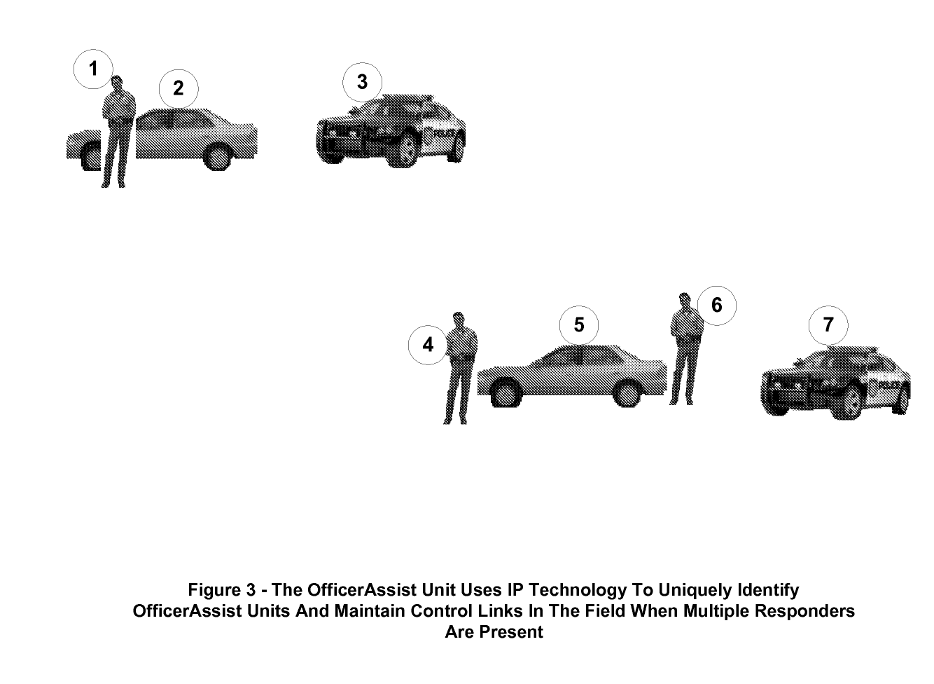

Typically in public safety, several officers will arrive on scene (FIG. 3 #s 1, 4 and 6) and their transport vehicles will each bring a control computer equipped with IP radio (FIG. 3 #s 3 and 7). But since the only bandwidth requirements are for brief message delivery, the quality of their audio recordings is not affected by the additional radios present.

What is claimed:

1) a method for implementing an automated system for the collection, archival and controlled access of real-time officer-citizen contact evidentiary digital data from a digital recording device (audio, video, photographic, with ancillary data) comprising;

2) a method for utilizing a computer program to automate the secure collection of digitally recorded data of claim (1) from a digital recording device to an archival system that manages said digitally recorded data such that said digitally recorded data is evidentiary, said computer program comprising:
a) a means for configuring a remote digital recording device in order to automatically identify data from a specific user;
b) a means to automate the recognition of a digital recording device connected to a field workstation and the preparation of its field configuration;
c) a means to automate the wireless activation of said digital recording device;
d) a means to automate the receiving of digital data from said digital data recording device and the processing of said digitally recorded data;
e) a means to automate the archival of said digitally recorded data and for making accessible, through secure procedures, said archived digitally recorded data;

3) the digital recording device of claim (2) may be configured using a restricted access program that writes onto said digital recording device a coded, hidden file identifying the authorized user or users, said restricted access program comprising:
a) a means to restrict access to said access program to authorized administrators with appropriate user name and password;
b) a means whereby a restricted access user may choose from two alternative configuration options for authorizing single or multiple users per digital recording device,
c) a means for writing a coded, hidden file to said digital recording device for future identification of said digital recording device, its selected configuration and its authorized users;

4) the means to automate the recognition of the digital recording device of claim (3) when connected to a field computer, which comprises:
a) a means to automate the detection of a digital recording device by reading and interpreting the coded, hidden file of claim (3) from said digital recording device;
b) a means to automate the synchronization of the time of day clock of said digital recording device with local workstation time by sending a coded message to said device;
c) a means to communicate with said digital recording device to set up its recording parameters such as type and quality of recording, and communication parameters such as IP address and ID;
d) a means to automate the enabling of controlled termination of the recording of digital data when said digital recording device is recognized by the field computer;

5) the digital recording device of claim (2) can be sent communications via IP radio link comprising:
a) a means to communicate with said digital recording device to transmit commands to said digital recording device to initiate recordings in response to a change in status of a monitored officer-initiated or vehicle susbsystem (e.g., emergency lights, vehicle door open, gun vault unlock, vehicle computer interaction, airbag deployment);
b) a means to receive acknowledgements from said digital recording device in response to said transmitted commands to verify receipt;

6) a means to automate the receiving of digital data of claim (2) whereby said computer program has the ability to receive digitally recorded data from digital recording device of claim (5) comprising:
a) a means to automate the receiving of wirelessly transmitted message packets containing digitally recorded data from said digital recording device and the recording of said digital data to local workstation storage;
b) a means to automate the reading and copying (offloading) of digitally recorded data from said digital recording device to workstation storage when said digital recording device is physically connected to workstation;
c) a means to automate the processing of said digitally recorded data and its formatting for archive storage.

7) a means to automate the processing of the digitally recorded data of claim (6) whereby digital recordings from the digital recording device of claims (3) is processed and formatted into one-minute digital files, said one-minute granularity enabling:
a) a means to facilitate the efficient wireless transmission of said recorded digital data;
b) a means whereby said one-minute files can be retained or discarded on the basis of preset configurable pre-event timing considerations, said events corresponding to selected officer-initiated or vehicle monitored subsystems (e.g., emergency lights, vehicle door open, gun vault unlock, vehicle computer interaction, airbag deployment);
c) a means to allow first-order editing functions on playback;
d) a means for using only mouse clicks to access a specific starting and ending minute on playback;
e) a means to enable an “at-a-glance” GUI which communicates an understanding of the exact placement in time of all digital recordings and recorded events (e.g., energizing of emergency lights, opening of a car door, unlocking of a gun vault).

8) a means to automate the archival of digitally recorded data of claim (7) and for making accessible, through secure procedures, said archived digitally recorded data comprising:
a) a means to automate the storage of said digitally recorded data in a long-term digital archive;
b) a means to restrict access to said digitally recorded data to properly authorized users by requiring a user id and password and assigning access to digitally recorded data on a hierarchical, per device basis;
c) a means to automate the recording of an entry describing each packet of digitally recorded data in an archive database to facilitate future retrieval and review of said digitally recorded data;
d) a means to automate the recording of ancillary data associated with said digitally recorded data in a database to facilitate future retrieval and review, said ancillary data might contain time archived, ID of user making recording, associated GPS data, associated other digital data (e.g., video, audio, photographic), Case or Event ID, Comments or keywords;
e) a means to automate the retrieval of said digitally recorded data either via directly requesting data by device ID, date, time or by requesting retrieval through any of the aforementioned ancillary data;
f) a means to graphically present to an authorized user a chart of data available by date and time;
g) a means to automate the collection of audit data for each request to view digitally recorded data, which might include date/time request was made, ID of user making request, identification of workstation from which request is made, data viewed, use made of data (viewing, redacting, recording, copying);
h) a means of reviewing said audit data by making it available as a function of date/time, user, device, or other ancillary data collected.

9) the digital recording device of claim (3), which is remote or worn on the officer's person, is equipped with a robust wireless mesh IP link, comprising:
a) a means to accept a command from the field computer to initiate recording in response to a change in status of a monitored subsystem;
b) a means to initiate recording on said digital recording device via a pressed button or verbal command into said digital recording device's input mechanism;
c) a means to initiate recording on associated digital recording devices (e.g., audio, video) in conjunction with said means to initiate recording, as in b above, by transmitting an initiation or emergency command from said digital recording device to aforementioned field computer;
d) a means to collect other citizen-based data (e.g. driver license bar codes/magnetic stripes, fingerprints, or iris imagers, etc.) for transmission to the field computer, said citizen-based data to be transmitted via the more powerful wireless system in vehicle to reach central data archives;
e) a means to transmit pertinent data received in response to aforementioned citizen-based data via IP radio transmission into officer's earpiece;
a means to automate the recording of the actual date/time aforementioned response data is transmitted to the using officer's earpiece.

10) the digital recording device of claim (9) provides a real-time, less than full-fidelity version of the recorded digital data (i.e., abstracted to fit the available bandwidth) to support tactical situations while preserving the full-fidelity evidentiary data comprising:
a) a means to reduce bandwidth requirements by transmitting narrow-band audio while simultaneously locally recording full-fidelity audio for offloading to storage when connected to field computer;
b) a means to reduce bandwidth by transmitting reduced video frame rate and frame size while simultaneously locally recording full-fidelity video for offloading to storage when connected to field computer.
